(19) United States
(12) Patent Application Publication
(10) Pub. No.: US 2011/0151427 A1
(43) Pub. Date: Jun. 23, 2011

(54) WRITABLE AND ILLUSTRATION-REPLACEABLE INTERPRETATIVE PANEL STRUCTURE

(75) Inventor: Richard Lin, TAIPEI COUNTY (TW)

(73) Assignee: POP THREE DIMENSIONAL PICTURE CO., LTD., TAIPEI COUNTY (TW)

(21) Appl. No.: 12/646,449

(22) Filed: Dec. 23, 2009

(51) Int. Cl. B43L 1/12; G09B 23/30

(52) U.S. Cl. 434/416; 434/262; 434/428

(57) ABSTRACT

A writable and illustration-replaceable interpretative panel structure includes an interpretative panel unit and a frame unit. The interpretative panel unit includes a first panel and a second panel arranged back to back. Each of the first and second panels has interpretative illustrations and interpretative text provided on an outer surface thereof. The frame unit includes a first frame member and a mating second frame member detachably connected to each other to securely clamp peripheral edges of the interpretative panel unit therebetween. Accordingly, the interpretative panel unit can be conveniently replaced with other interpretative panel units that provide different interpretative illustrations and text. A transparent sheet is attached to the outer surface of each of the first and second panels, and the frame unit has a holder for holding a write/erase unit, so that supplemental information can be written on and erased from the transparent sheets with the write/erase unit.

### FIELD OF THE INVENTION

The present invention relates generally to an interpretative panel, and more particularly to a writable and illustration-replaceable interpretative panel structure.

### BACKGROUND OF THE INVENTION

An interpretative panel is frequently used to enable better communication between two parties, such as a lecturer and the audience, a doctor and a patient and the patient's family, etc. For example, the doctor can help a patient and the patient's family to understand the disease with an interpretative panel illustrating a human organ diagram and related interpretative text.

A conventional interpretative panel includes a panel set in a frame. The panel has interpretative illustrations and text provided on one side thereof. With the interpretative panel, a user, such as a doctor, can more clearly convey his idea to another person, such as a patient.

In the conventional interpretative panel, the panel is fixedly set in the frame and could not be replaced with other panels showing different interpretative illustrations and text. Moreover, the interpretative illustrations and text are generally provided only on one single side of the panel to limit the scope of information that can be provided via the interpretative panel. Also, the conventional interpretative panel does not allow a user to write thereon for providing more information to supplement the interpretative illustrations and text shown on the interpretative panel.

### SUMMARY OF THE INVENTION

A primary object of the present invention is to provide a writable and illustration-replaceable interpretative panel structure that includes an interpretative panel unit having interpretative illustrations and text provided on both sides thereof, allowing supplementary information to be written on and erased from both sides thereof, and being replaceable with other interpretative panel units that provide different interpretative illustrations and text.

To achieve the above and other objects, the writable and illustration-replaceable interpretative panel structure according to the present invention includes an interpretative panel unit having a first panel and a second panel arranged back to back, each of the first and the second panel having interpretative illustrations and interpretative text provided on an outer surface thereof; and a frame unit including a first frame member and a mating second frame member detachably connected to each other to securely clamp peripheral edges of the interpretative panel unit therebetween. Accordingly, the interpretative panel unit can be conveniently replaced with other interpretative panel units provided with different interpretative illustrations and interpretative text.

In an embodiment of the present invention, a connection unit is provided on the first and second frame members at two facing sides for detachably connecting the first and the second frame member together to complete the frame unit.

In an embodiment of the present invention, the first frame member has an inner side and the second frame member also has an inner side opposite to the inner side of the first frame member; and the connection unit includes a plurality of insertion posts provided on the inner side of the first frame member and a plurality of receiving holes provided on the inner side of the second member corresponding to the insertion posts. The insertion posts can be detachably inserted into the receiving holes to connect the first and the second frame member to each other.

In an embodiment of the present invention, a transparent sheet is attached to the outer surface of each of the first and second panels; and a holder is provided on a peripheral edge of the frame unit for holding a write/erase unit thereto. With the write/erase unit, supplemental information can be written on and erased from the interpretative panel unit.

In an embodiment of the present invention, the holder includes a first holding bracket and a second holding bracket provided on the peripheral edge of the first and the second frame member, respectively.

In an embodiment of the present invention, the write/erase unit includes a pen and an erasing member. The erasing member includes an eraser and a sleeve, and the eraser is removably connected to the pen via the sleeve that can be fitted on an end of the pen.

In an embodiment of the present invention, a pad is sandwiched between the first and the second panel to increase an overall thickness of the interpretative panel unit, allowing the interpretative panel unit to be securely held in the frame unit.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an exploded perspective view of a writable and illustration-replaceable interpretative panel structure according to an embodiment of the present invention;

FIG. 2 is an assembled view of FIG. 1;

FIG. 3 shows a longitudinally sectioned perspective view of the writable and illustration-replaceable interpretative panel structure according to the present invention and an enlarged view of the circled area thereof;

FIG. 4 shows the use of a write/erase unit to write on an interpretative panel unit of the present invention; and

FIG. 5 shows the use of the write/erase unit to erase ink marks from the interpretative panel unit of the present invention.

### DETAILED DESCRIPTION OF THE PREFERRED EMBODIMENTS

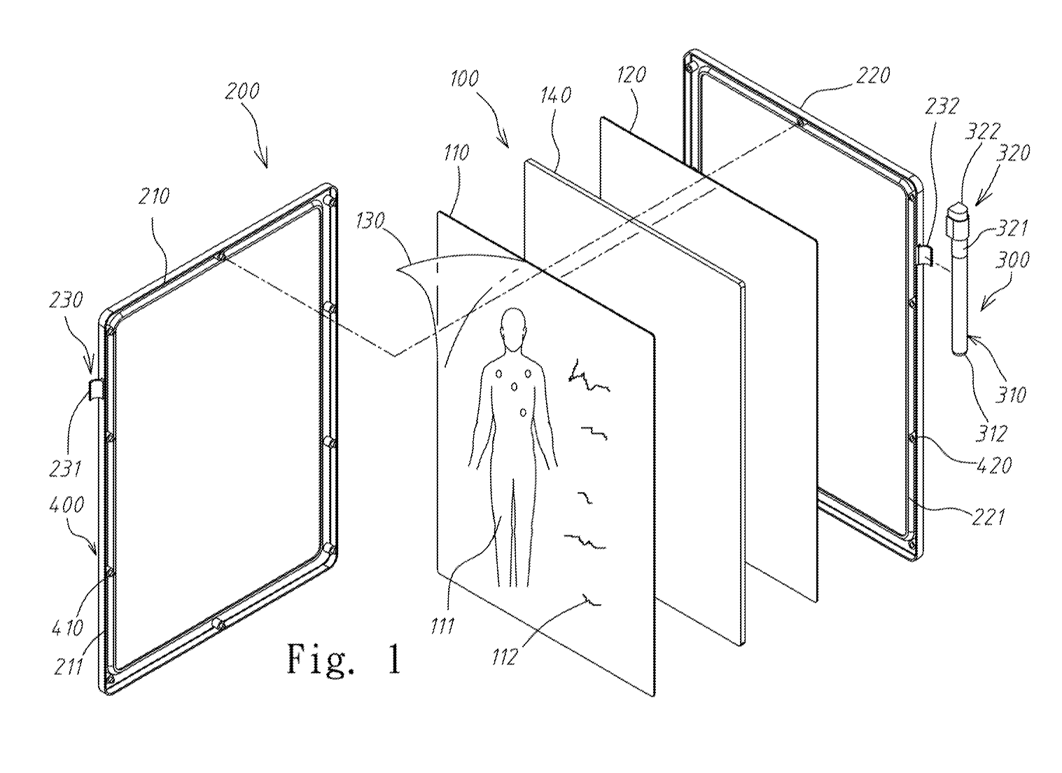

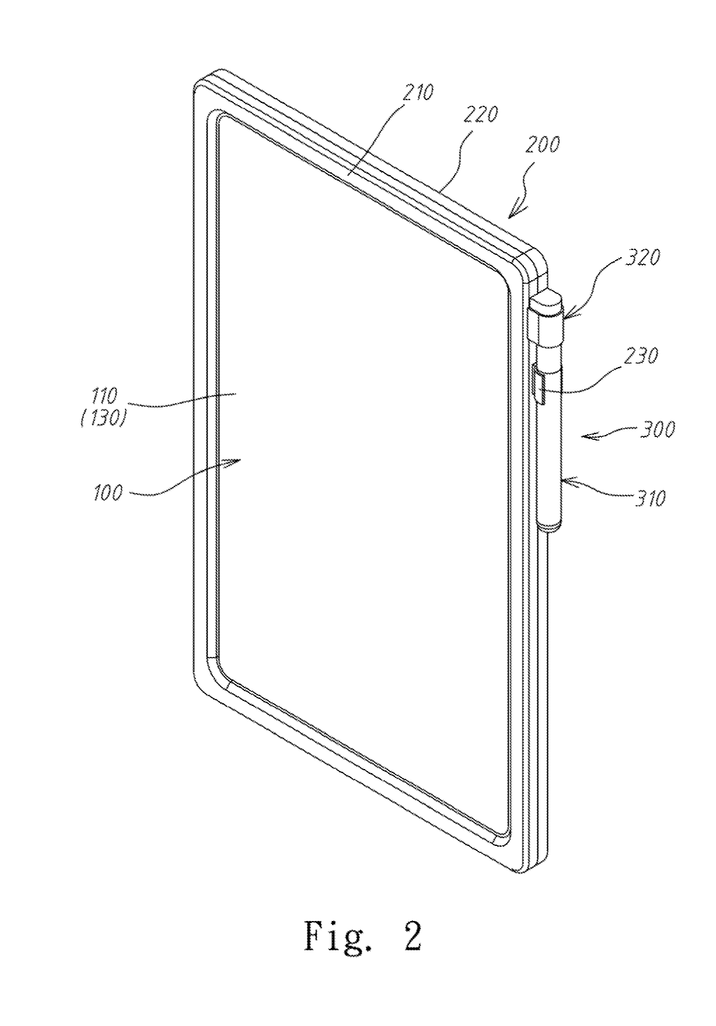

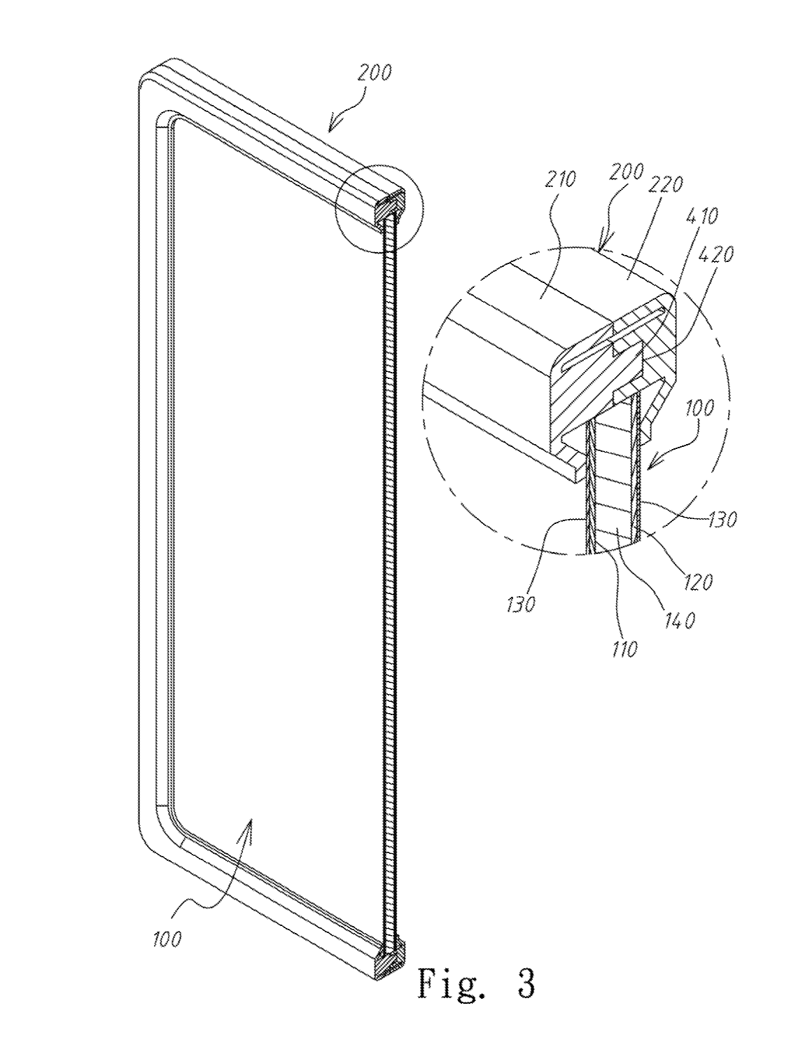

Please refer to FIGS. 1 to 3, in which FIG. 1 is an exploded perspective view of a writable and illustration-replaceable interpretative panel structure according to an embodiment of the present invention, FIG. 2 is an assembled view of FIG. 1, and FIG. 3 is a longitudinally sectioned perspective view of FIG. 2. As shown, the writable and illustration-replaceable interpretative panel structure includes an interpretative panel unit 100, a frame unit 200, and a write/erase unit 300.

The interpretative panel unit 100 includes a first panel 110 and a second panel 120 arranged back to back. Each of the first and second panels 110, 120 has interpretative illustrations 111 and interpretative text 112 shown on an outer surface thereof, such as a human organ diagram and related written description thereof. A transparent sheet 130 is attached to the outer surface of each of the first and second panels 110, 120 to allow a user to write thereon with, for example, an oil-based pen. In practice, the transparent sheet 130 can be an independent member, such as a transparent acrylic plate attached to the outer surface of each of the first and second interpretative panels. Alternatively, the outer surface of each of the first and second interpretative panels can be directly coated with a layer of transparent film.

For the interpretative panel unit 100 to properly have a predetermined thickness and be securely clamped in the frame unit 200, a pad 140 is sandwiched between the first and the second panel 110, 120 to increase an overall thickness of the interpretative panel unit 100.

The frame unit 200 includes a first frame member 210 and a mating second frame member 220, which are detachably connected to each other to firmly clamp peripheral edges of the interpretative panel unit 100 therebetween. A connection unit 400 is provided on the first and the second frame member 210, 220 at two facing sides thereof for detachably connecting the first frame member 210 and the second frame member 220 together to thereby complete the frame unit 200. More specifically, the first frame member 210 has an inner side 211 and the second frame member 220 has an inner side 221 facing toward the inner side 211; and the connection unit 400 includes a plurality of insertion posts 410 provided on the inner side 211 of the first frame member 210 and a plurality of receiving holes 420 provided on the inner side 221 of the second frame member 220 corresponding to the insertion posts 410. By inserting the insertion posts 410 into the corresponding receiving holes 420, the first and the second frame member 210, 220 can be assembled together to form the complete frame unit 200 for securely clamping the interpretative panel unit 100 between the first and the second frame member 210, 220. Reversely, when the insertion posts 410 are disengaged from the receiving holes 420, the first and second frame members 210, 220 are separated from each other. With the detachably connected first and second frame members 210, 220, the interpretative panel unit 100 can be conveniently replaced with other interpretative panel units that provide different interpretative illustrations and text.

A holder 230 is provided on an outer edge of the frame unit 200 for holding the write/erase unit 300 thereto. The write/erase unit 300 can be removed from the holder 230 for writing on the interpretative panel unit 100. The holder 230 includes a first holding bracket 231 and a second holding bracket 232, which are correspondingly provided on the first and the second frame member 210, 220, respectively, to together hold the write/erase unit 300 therebetween. The write/erase unit 300 includes a pen 310, such as an oil-based pen, and an erasing member 320. The erasing member 320 includes an eraser 321 and a sleeve 322. The erasing 321 is detachably connected to the pen 310 via the sleeve 322 that can be fitted to an end of the pen 310.

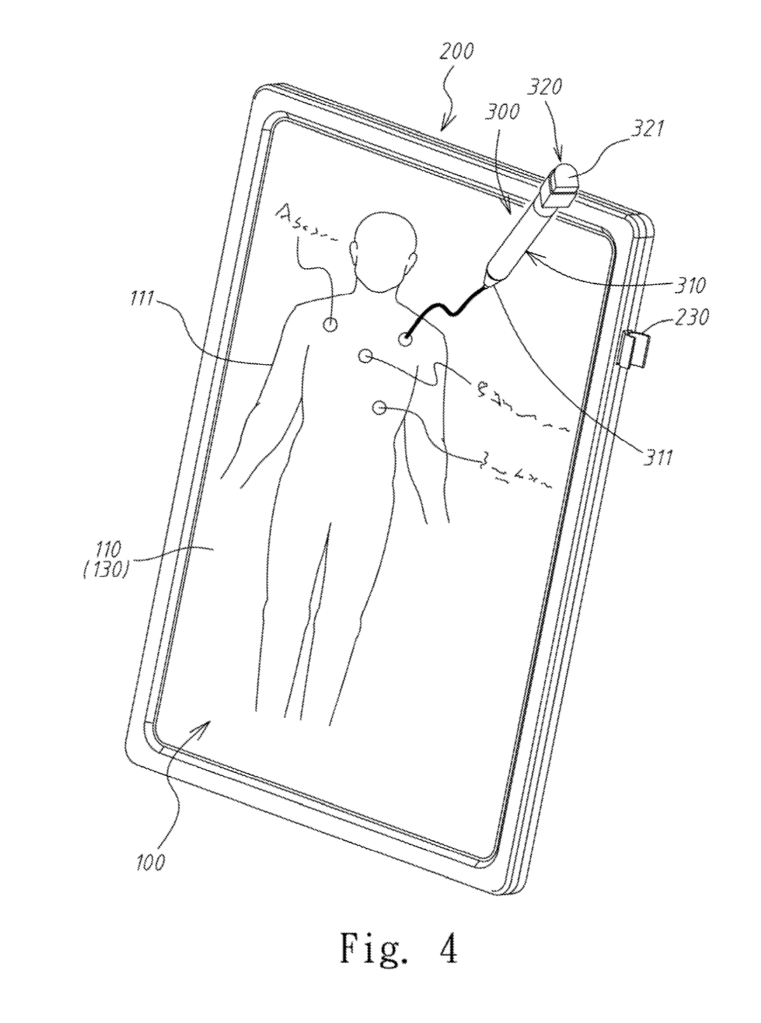

Please refer to FIG. 4 that shows the use of the write/erase unit 300 to write on the interpretative panel unit 100 of the writable and illustration-replaceable interpretative panel structure of the present invention. In the event the interpretative illustrations 111 and interpretative text 112 provided on the outer surfaces of the first and second panels 110, 120 are not sufficient for use, a user can provide supplemental information by writing on the interpretative panel unit 100 with the pen 310. To do this, the user first removes the erasing member 320 to expose a front tip 311 of the pen 310 and then fixes the erasing member 320 to an opposing rear end 312 of the pen 310 using the sleeve 322. Thereafter, the user can freely write supplementary information on the outer surfaces, that is, on the transparent sheets 130, of the first and second panels with the pen 310 to help another person to understand what the user is trying to explain.

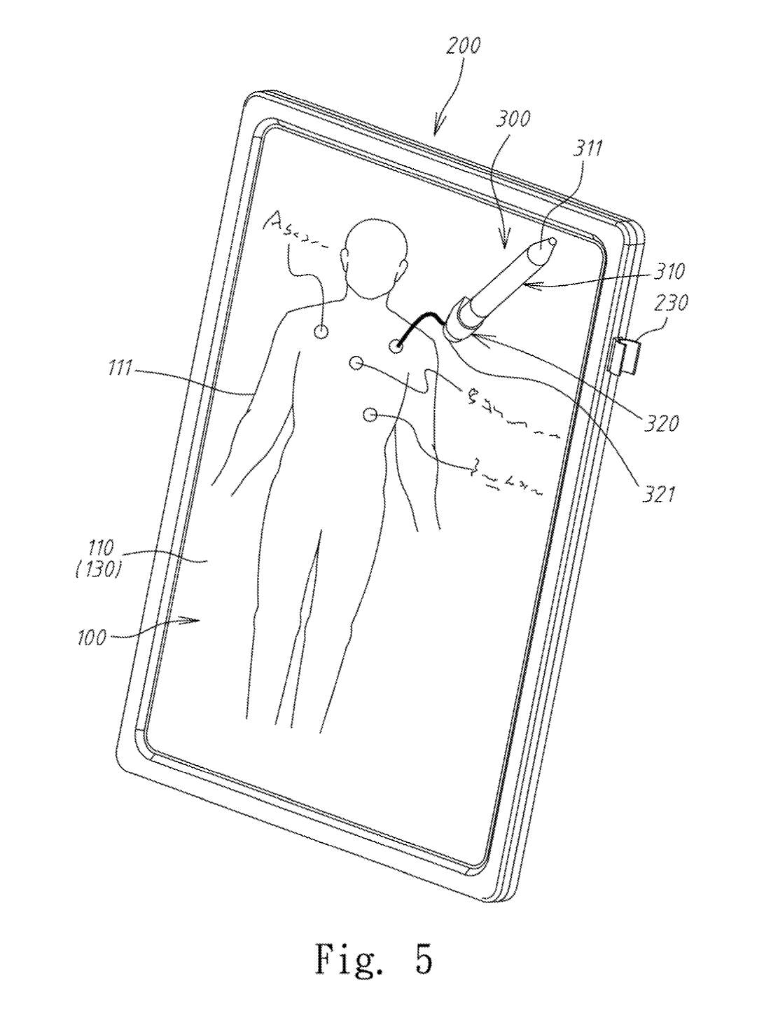

FIG. 5 shows the use of the write/erase unit 300 to erase ink marks of the supplementary information from the interpretative panel unit 100. To remove the user-written supplementary information from the first and second panels 110, 120, simply use the eraser 321 of the erasing member 320 to erase the ink marks of the supplemental information from the first and second panels 110, 120, and the outer surfaces of the first and second panels 110, 120 are cleaned to show only the original interpretative illustrations and text again. Thus, supplementary information can be written on and erased from the interpretative panel unit 100 with the pen 310 and the eraser 321, respectively, allowing the interpretative panel unit 100 to be repeatedly utilized.

According to the above arrangements, the interpretative panel unit of the interpretative panel structure of the present invention is writable and illustration-replaceable, and has interpretative illustrations and text shown on both sides thereof. Therefore, the writable and illustration-replaceable interpretative panel structure of the present invention provides good applicability.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A writable and illustration-replaceable interpretative panel structure comprising:
an interpretative panel unit including a first panel and a second panel arranged back to back, and each of the first and the second panel having interpretative illustrations and interpretative text provided on an outer surface thereof; and
a frame unit including a first frame member and a mating second frame member detachably connected to each other to securely clamp peripheral edges of the interpretative panel unit therebetween.

2. The writable and illustration-replaceable interpretative panel structure as claimed in claim 1, wherein a connection unit is provided on the first and the second frame member at two facing sides for detachably connecting the first and the second frame member together to thereby complete the frame unit.

3. The writable and illustration-replaceable interpretative panel structure as claimed in claim 2, wherein the first frame member has an inner side and the second frame member has an inner side facing toward the inner side of the first frame member, and the connection unit includes a plurality of insertion posts provided on the inner side of the first frame member and a plurality of receiving holes provided on the inner side of the second frame member corresponding to the insertion posts.

4. The writable and illustration-replaceable interpretative panel structure as claimed in claim 3, wherein each of the first and the second panel has a transparent sheet attached to the outer surface thereof, and the frame unit is provided on a peripheral edge thereof with a holder for holding a write/erase unit thereto.

5. The writable and illustration-replaceable interpretative panel structure as claimed in claim 4, wherein the holder includes a first holding bracket and a second holding bracket correspondingly provided on the peripheral edge of the first and the second frame member, respectively.

6. The writable and illustration-replaceable interpretative panel structure as claimed in claim 5, wherein the write/erase unit includes a pen and an erasing member, the erasing member including an eraser and a sleeve, and the sleeve being fitted on an end of the pen to detachably connect the eraser to the pen.

7. The writable and illustration-replaceable interpretative panel structure as claimed in claim 1, wherein a pad is sandwiched between the first and the second panel to increase an overall thickness of the interpretative panel unit.
